(19) United States
(12) Patent Application Publication
(10) Pub. No.: US 2025/0364621 A1
(43) Pub. Date: Nov. 27, 2025

(54) TRACTION BATTERY FOR A MOTOR VEHICLE AND METHOD FOR PRODUCING A TRACTION BATTERY

(71) Applicant: AUDI AG, Ingolstadt (DE)

(72) Inventors: Marc GORMANNS, Erlenbach (DE); Sebastian KUNZE, Dietfurt an der Altmühl (DE); Erich LEHNER, Bad Friedrichshall (DE); Daniel SCHMID, Stammham (DE); Michael SCHÜßLER, Neckarsulm (DE); Diana WALENWEIN, lngolstadt (DE)

(73) Assignee: AUDI AG, Ingolstadt (DE)

(21) Appl. No.: 19/211,593

(22) Filed: May 19, 2025

(30) Foreign Application Priority Data
May 24, 2024 (DE) 102024114606.0

(51) Int. Cl. H01M 10/63; B60L 50/64; B60L 58/24; H01M 10/625; H01M 10/647; H01M 10/653; H01M 10/656; H01M 50/209; H01M 50/249

(52) U.S. Cl. CPC H01M 10/63; B60L 50/64; B60L 58/24; H01M 10/625; H01M 10/647; H01M 10/653; H01M 10/656; H01M 50/209; H01M 50/249; H01M 2220/20

(57) ABSTRACT

A traction battery for a motor vehicle, with a cell module having a battery cell arrangement and a temperature control device for temperature control of the battery cell arrangement. The temperature control device has a temperature control element having at least one fluid channel, against which the battery cell arrangement rests in a first direction and from which a holding projection extends, against which the battery cell arrangement is supported in a second direction different from the first direction.

### FIELD

The invention relates to a traction battery for a motor vehicle, comprising a cell module having a battery cell arrangement and a temperature control device for temperature control of the battery cell arrangement. The invention further relates to a method for producing a traction battery.

### BACKGROUND

For example, document DE 10 2011 116 525 B4, is known from the prior art. This describes a battery module comprising: a plurality of battery cells; a plurality of cooling rib assemblies, wherein each cooling rib assembly is positioned between two battery cells, the cooling rib assemblies comprising at least one cooling rib and a foot on at least one side of the cooling rib assemblies, the foot having a bottom and coupling profiles on each end, and the coupling profiles on adjacent feet of the cooling rib assemblies coupling the feet and forming a surface; and a heat sink in contact with the surface of the coupled feet, wherein the cooling rib assemblies comprise a pair of cooling ribs, and wherein the cooling rib assemblies further comprise an expansion unit between the pair of cooling ribs.

Furthermore, document DE 10 2012 215 815 B4 discloses a battery module comprising: a plurality of repeating frames; a plurality of battery cells positioned between the plurality of repeating frames, each battery cell being surrounded by a flexible thermally conductive bag formed from a metal-polymer laminate film and having an extended edge rib on at least one side, the extended edge rib of the thermally conductive bag being folded over an outside edge of one of the plurality of repeating frames; and a heat sink in contact with the extended edge rib of the thermally conductive bag folded over the edge of the repeating frame.

Furthermore, from document DE 10 2015 114 396 A1, a vehicle traction battery heat sink is known, comprising: a first rib having a cell contact portion in thermal contact with a plurality of battery cells and a connector portion extending from the cell contact portion; and a heat plate in thermal contact with the connector portion and with a heating medium circulated within the heat plate, wherein heat is exchanged between the plurality of battery cells and the heat plate through the rib.

Finally, EP 3 439 098 B1 discloses a battery pack for an electric vehicle, comprising: a heat-radiating plastic pack having a plurality of stacked heat-radiating cassettes, each of which is packed with a pair of batteries; and a heat-radiating module comprising a vapor chamber in contact with the heat-radiating plastic pack for uniformly collecting heat generated by the heat-radiating plastic pack, a heat sink for spreading and dissipating the collected heat of the vapor chamber; and a heat exchanger for lowering the temperature of the heat sink, wherein the heat radiating cassette comprises a frame structure comprising a receiving through-hole arranged in a central region for receiving a pair of batteries, and a seat portion formed on an inner peripheral wall of the receiving through-hole for supporting the pair of batteries, wherein the frame structure is molded with a heat radiating resin and comprises an aluminum frame that is insert-injection molded.

### SUMMARY

It is an object of the invention to propose a traction battery for a motor vehicle which has advantages over known traction batteries, in particular enabling effective temperature control of the battery cell arrangement of the cell module even with a high energy storage density of the traction battery.

This is achieved according to the invention with a traction battery for a motor vehicle. It is provided that the temperature control device has a temperature control element having at least one fluid channel, against which the battery cell arrangement rests in a first direction and from which a holding projection extends, against which the battery cell arrangement is supported in a second direction different from the first direction.

It is pointed out that the embodiments explained in the description are not limiting; rather, any variations of the features disclosed in the description, the claims and the figures can be implemented.

The traction battery is preferably part of the motor vehicle, but can of course also be present separately from it, in particular before the traction battery is fitted on or in the motor vehicle. The traction battery is intended and designed for the temporary storage of electrical energy for a drive device of the motor vehicle. The drive device is used to drive the motor vehicle and thus to provide a drive torque that is for driving the motor vehicle. To provide the drive torque, the drive device has at least one drive unit which is designed as an electric traction machine that is electrically connected to the traction battery.

The electrical energy stored in the traction battery is thus used to drive at least temporarily the motor vehicle, thus to provide a drive torque intended to drive the motor vehicle by means of the drive device or the drive unit. Conversely, it can be provided that electrical energy provided by the drive device is temporarily stored in the traction battery.

The traction battery has the battery cell arrangement, which in turn has at least one battery cell, i.e. in particular exactly one battery cell or multiple battery cells. If in this description the battery cell or the at least one battery cell is mentioned, the statements are always equivalent. Explanations regarding the at least one battery cell are applicable to the battery cell and vice versa. If the battery cell arrangement has a plurality of battery cells, the explanations for the battery cell or the at least one battery cell are transferable to the battery cells, in particular to each of the plurality of battery cells. The battery cell is preferably a prismatic cell or a pouch cell.

The battery cell arrangement together with the temperature control device forms the cell module of the traction battery. The cell module is, for example, a component of a battery module of the traction battery, which in addition to the cell module preferably has end plates and/or a clamping device. The battery module can have one or more cell modules. In particular, the cell modules of the battery module are designed identically, so that the statements in this description for the cell module are applicable to each of the plurality of cell modules of the battery module. The cell module or the plurality of cell modules are arranged between the end plates and clamped by means of the clamping device to form the battery module.

The end plates are, for example, part of a battery module housing. The end plates accommodate the cell module or the cell modules, in particular the battery cell arrangement or the battery cell arrangements of the cell modules, between them. In this respect, the end plates are arranged on opposite sides of the cell module or cell modules. Preferably, the battery cell arrangement is cuboid-shaped or at least approximately cuboid-shaped.

If the battery cell arrangement has multiple battery cells, these are preferably electrically interconnected. For this purpose, the battery cells are arranged, for example, in such a way that their electrical connections are arranged on the same side and/or face each other. The connections are, for example, electrically connected to one another by means of a plurality of busbars, which are preferably also electrically connected to electrical connections of the cell module and/or the battery module. In other words, the battery cells of the cell module are electrically connected to the terminals via the busbars.

Preferably, the traction battery has a battery housing in which a battery module receptacle is configured, which is provided and configured to receive the battery module or a plurality of battery modules. During the production of the traction battery, the battery module is inserted into the battery module receptacle. Preferably, not only a single battery module is arranged in the battery housing, but rather multiple battery modules are introduced into the battery housing. In such an embodiment, the battery housing has a battery module receptacle which is designed to accommodate multiple battery modules, or multiple battery module receptacles.

During operation of the traction battery, heat is generated in the battery cell arrangement, which must be dissipated from it, or heat must be supplied to reach a certain temperature of the battery cell arrangement. Accordingly, the traction battery or cell module has the temperature control device by means of which the battery cell arrangement is at least temporarily tempered. With the aid of the temperature control device, heat is at least temporarily removed from the battery cell arrangement and/or heat is supplied to the battery cell arrangement using the temperature control device.

The temperature control device is usually part of the battery housing, in particular a base plate of the battery housing. During assembly of the traction battery, the cell module is inserted into the battery housing in such a way that the battery cell arrangement is subsequently connected to the temperature control device or the base plate in a heat-transfer manner. To ensure a reliable connection of the battery cell arrangement to the temperature control device, a heat transfer medium can be used. This is sometimes also referred to as a “gap filler”. However, such a design of the traction battery only allows the heat to be dissipated or supplied over a comparatively small region of the battery cell arrangement. Accordingly, achieving a uniform temperature distribution in the battery cell arrangement is challenging.

For this reason, the invention provides that the temperature control device has the temperature control element. At least one fluid channel is formed in the temperature control element, through which a fluid flows at least partially for temperature control of the battery cell arrangement. In other words, the fluid is supplied to the fluid channel for temperature control of the battery cell arrangement at least temporarily on the one hand and removed on the other hand. In particular, the fluid channel is fluidically connected to a fluid circuit. The temperature control element is in particular different from the base plate of the battery housing; preferably, it is arranged at a distance from the base plate and/or at an angle to the base plate. When using the temperature control element, it is not necessary to design the base plate for temperature control of the battery cell arrangement. The base plate can therefore be designed without fluid channels. Of course, it is also possible to create a fluid channel in the base plate through which the fluid flows, at least temporarily.

Of course, only a single fluid channel can be created in the temperature control element. Preferably, however, there are multiple fluid channels in the temperature control element, which are preferably fluidically connected in parallel. The fluid flows through the multiple fluid channels simultaneously or in parallel. If in this description the at least one fluid channel or the fluid channel is mentioned, the statements are always equivalent. Explanations regarding the at least one fluid channel are therefore transferable to the fluid channel and statements regarding the fluid channel are transferable to the at least one fluid channel. If there are multiple fluid channels, the explanations regarding the at least one fluid channel or the fluid channel can preferably be transferred to each of the multiple fluid channels.

The temperature control element is mechanically connected to the battery cell arrangement, namely using the holding projection. The holding projection starts from the temperature control element and thus protrudes beyond it. The battery cell arrangement is arranged adjacent to the temperature control element, namely in such a way that it rests against the temperature control element in the first direction. The contact of the battery cell arrangement with the temperature control element in the first direction can be direct or only indirect. In the case of direct contact of the battery cell arrangement, the battery cell arrangement lies directly against a contact surface of the temperature control element, in particular flatly. The battery cell arrangement is therefore directly adjacent to the temperature control element.

In the case of indirect contact, the battery cell arrangement and the temperature control element are spaced apart from each other, for example by a heat transfer medium present between them. In this case, the temperature control element is arranged on the one side and the battery cell arrangement on the other side of the heat transfer medium, wherein the heat transfer medium lies directly on the temperature control element or adjoins it on a first side and on the battery cell arrangement on a second side opposite the first side. The contact of the battery cell arrangement with the temperature control element in the first direction is also to be understood as a support of the battery cell arrangement on the temperature control element in the first direction.

The battery cell arrangement is preferably guided or mounted in the first direction by means of the holding projection with respect to the temperature control element. In this respect, the holding projection preferably allows a displacement of the battery cell arrangement with respect to the temperature control element or vice versa in the first direction. For this purpose, the battery cell arrangement is supported on the holding projection in the second direction. The second direction is different from the first direction, preferably it is angled relative to the first direction. This means in particular that the first direction and the second direction together form an angle which is greater than 0° and less than 180°. For example, the angle is at least 60° and at most 120°, at least 80° and at most 100°, at least 85° and at most 95°. Particularly preferably, the angle is approximately or exactly 90°, with the two directions being thus perpendicular to each other.

Preferably, the holding projection is designed such that, after the traction battery has been mounted, it is present between the base plate of the battery housing and the battery cell arrangement, so that the battery cell arrangement is supported on the base plate via the holding projection. It can be provided that the base plate has recesses which are provided and designed to receive the holding projection. During assembly of the traction battery, the holding projection is inserted into the recess and is subsequently preferably held therein, in particular in a form-fitting manner. The holding projection and the recess are particularly preferably dimensioned such that after the installation of the traction battery, the battery cell arrangement rests against the base plate at least in portions, namely away from the holding projection. This ensures particularly reliable guidance of the battery cell arrangement, which also allows for expansion-related displacement of the battery cell arrangement.

In addition, the holding projection is connected to the temperature control element, so that it serves as an additional thermal connection between the battery cell arrangement and the temperature control element. Heat is transferred between the temperature control element and the battery cell arrangement not only in the first direction, but also in the second direction via the holding projection. This results in particularly good efficiency in temperature control.

A further development of the invention provides that the battery cell arrangement is in contact with the temperature control element via a heat transfer medium, so that the temperature control element is thermally coupled to the battery cell arrangement via the heat transfer medium. The expansion of the battery cell arrangement and the resulting dimensional change of the battery cell arrangement can lead to a deterioration of the heat transfer between the battery cell arrangement and the temperature control element. In order to achieve a particularly reliable thermal connection between the temperature control element and the battery cell arrangement, the heat transfer medium is therefore inserted between the temperature control element and the battery cell arrangement.

The temperature control element is thermally coupled to the battery cell arrangement via the heat transfer medium; for this purpose, the heat transfer medium is accommodated between the temperature control element and the battery cell arrangement and lies on the one hand against the temperature control element and on the other hand against the battery cell arrangement, in particular in a flat manner. With the help of the heat transfer medium, the thermal connection between the battery cell arrangement and the temperature control element can be maintained and thus ensured even in the event of significant dimensional changes in the battery cell arrangement.

A further development of the invention provides that the heat transfer medium is a foam, a thermal pad or a thermal paste. The foam is a thermally conductive foam, which consists of a thermally conductive material, for example metal or plastic, or at least contains it. It can be provided that the material has a plastic matrix in which the thermally conductive material, preferably metal or carbon, is embedded. The thermal pad is, for example, a flexible, thermally conductive element that is arranged between the battery cell arrangement and the temperature control element. The thermal pad is preferably self-adhesive, i.e. provided with an adhesive layer.

For example, the heat transfer medium is self-adhesive on one side only or self-adhesive on both sides. In the first case, the thermal pad is glued to the battery cell arrangement or the temperature control element, whereas it merely rests on the other component. In the latter case, the thermal pad is glued to both the battery cell arrangement and the temperature control element. Alternatively, the heat transfer medium is available in the form of thermal paste. A thermal paste is a viscous, thermally conductive material. For example, the thermal paste contains silicone. This has the advantage that when the thermal paste is exposed to heat during operation of the traction battery, ceramification occurs.

A further development of the invention provides that the holding projection overlaps the battery cell arrangement in the first direction over at least 50%, at least 75% or at least 100%. In other words, the holding projection has dimensions in the first direction which correspond to at least 50%, at least 75% or at least 100% of the dimensions of the battery cell arrangement in the same direction. It follows that the battery cell arrangement is supported on the holding projection over one of the said extensions, so that a reliable guidance of the battery cell arrangement with respect to the temperature control element is realized. As already explained, the battery cell arrangement is preferably arranged displaceably on the holding projection, so that a displacement of the battery cell arrangement and the temperature control element relative to one another in the first direction is permitted in order to compensate for thermally induced dimensional changes of the battery cell arrangement in the first direction. This reduces thermal stresses in the traction battery.

A further development of the invention provides that the holding projection is flush with the battery cell arrangement on a side of the battery cell arrangement facing away from the temperature control element. This means that the holding projection projects beyond the temperature control element in the direction of the battery cell arrangement, but not beyond the battery cell arrangement, in particular when viewed in the first direction. Ultimately, the holding projection does not project beyond the battery cell arrangement, so that multiple cell modules can be arranged next to each other in a simple manner, namely next to each other in the first direction. For example, it is provided that the holding projection rests in the first direction against a further temperature control element which is arranged on the side of the battery cell arrangement opposite the temperature control element and is present in particular as a component of a further cell module. This ensures particularly reliable guidance of the battery cell arrangement and also excellent thermal connection.

A further development of the invention provides that the temperature control element and the holding projection are manufactured in one piece and from the same material, in particular as an extruded profile. The temperature control element and the holding projection are therefore a combined component, which is made entirely of the same material and is therefore of the same material. Preferably, the component is manufactured by extrusion, so that the temperature control element and the holding projection are designed together as an extruded profile. This enables particularly simple and efficient production of the traction battery.

A further development of the invention provides that the holding projection has dimensions in a third direction different from the first direction and the second direction, which correspond to at most 40%, at most 20% or at most 10% of the dimensions of the temperature control element and/or the battery cell arrangement in the same direction. Preferably, the third direction is perpendicular to the first direction and the second direction, which in turn are perpendicular to each other. Consequently, the first direction, the second direction and the third direction form a Cartesian coordinate system. The first direction describes a transverse direction of the temperature control element, the second direction a vertical direction and the third direction a longitudinal direction of the temperature control element.

In the first direction the temperature control element has its width, in the second direction its height and in the third direction its length. The length is preferably greater than the height, which in turn is greater than the width. In the third direction, the holding projection is smaller than the temperature control element, i.e. it has smaller dimensions than the latter. Preferably, the dimensions of the holding projection in the third direction are at most the already mentioned dimensions of the temperature control element or the battery cell arrangement in the third direction. This results in a low weight of the holding projection and easy installation of the traction battery.

A further development of the invention provides that the cell module is a first cell module, the battery cell arrangement is a first battery cell arrangement, the temperature control element is a first temperature control element and the holding projection is a first holding projection and in addition to the first cell module there is a second cell module with a second battery cell arrangement and a second temperature control element, wherein the second battery cell arrangement rests against the first temperature control element in the first direction and a second holding projection extends from the second temperature control element, on which holding projection the second battery cell arrangement is supported in the second direction.

The first temperature control element is thus arranged between the first battery cell arrangement and the second battery cell arrangement, as seen in the first direction. The two battery cell arrangements are therefore supported in the first direction on opposite sides on the first temperature control element or accommodate it between them. The heat transfer medium may be present between the first temperature control element and each of the battery cell arrangements; however, the respective battery cell arrangement may also be in direct contact with the first temperature control element.

The second holding projection extends from the second temperature control element, on which projection the second battery cell arrangement is supported in the second direction. In this respect, the second cell module is designed analogously to the first cell module, in particular it is identical to it. For example, there are multiple second cell modules arranged next to each other to form the battery module. This allows the achievement of the advantages already described.

A further development of the invention provides that a further first holding projection extends from the first temperature control element, which further projection is offset with respect to the second holding projection in the third direction different from the first direction and the second direction and is arranged overlapping therewith in the first direction and in the second direction. The first cell module therefore not only has the first holding projection, but also the additional first holding projection. There may be several further first holding projections; the following explanations are applicable to each of these holding projections.

The further first holding projection extends, for example, as seen in the first direction, in the direction facing away from the first holding projection, so that the first holding projection and the further first holding projection run in opposite directions or extend in opposite directions away from the first temperature control element. The further first holding projection overlaps the second holding projection, for example there are several further first holding projections which receive the second holding projection between them, in particular when viewed in the third direction. Accordingly, a type of meshing of the holding projections is realized so that the first temperature control element and the second temperature control element are held positively to one another in the third direction.

The invention further relates to a method for producing a traction battery for a motor vehicle, in particular a traction battery according to the embodiments within the scope of this description, wherein the traction battery has a cell module comprising a battery cell arrangement and a temperature control device for temperature control of the battery cell arrangement. It is provided that the temperature control device has a temperature control element having at least one fluid channel, against which the battery cell arrangement rests in a first direction and from which a holding projection extends, against which the battery cell arrangement is supported in a second direction different from the first direction.

The advantages of such procedure or embodiment of the traction battery have already been discussed. Both the traction battery and the method for its production can be developed further according to the statements made in the context of the present description

The features and feature combinations described in the description, in particular the features and feature combinations described below in the description of the figures and/or shown in the figures may be used not only in the respective specified combination, but also in other combinations or alone, without departing from the scope of the invention. The invention should therefore also be considered to comprise embodiments that are explicitly not shown or explained in the description and/or the figures, but emerge from the explained embodiments or can be derived from them.

### BRIEF DESCRIPTION OF THE FIGURES

In the following, the invention will be explained in greater detail with reference to the exemplary embodiments depicted in the drawings, without this restricting the invention. In particular:

FIG. 1 shows a schematic illustration of a region of a traction battery of a motor vehicle, namely of a cell module having a battery cell arrangement and a temperature control device, and

FIG. 2 shows a schematic sectional view of the cell module, showing a holding projection extending from the temperature control element, on which the battery cell arrangement is supported.

### DETAILED DESCRIPTION

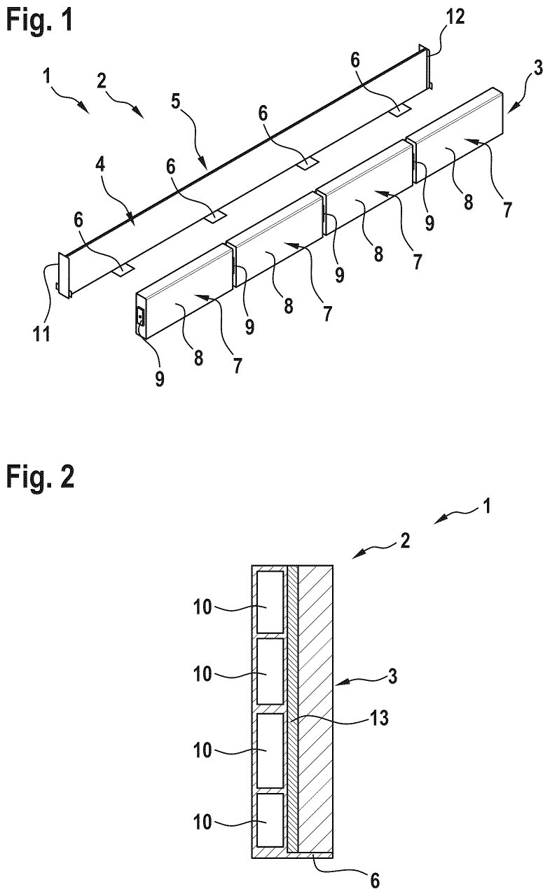

FIG. 1 shows a schematic representation of a part of a traction battery 1 for a motor vehicle, namely a cell module 2 of the traction battery 1 in an exploded view. The cell module 2 has a battery cell arrangement 3, a temperature control element 4 of a temperature control device 5 and a plurality of holding projections 6. In the illustrated embodiment, the battery cell arrangement 3 has a plurality of battery cells 7, which are present as prismatic battery cells. The battery cells 7 each have a cell housing 8 on which electrodes 9 are arranged on the front side. The electrodes 9 of battery cells 7 arranged adjacent to one another, which are only partially visible here, are electrically connected to one another, for example they lie against one another for this purpose.

It can be seen that the battery cells 7 or their cell housings 8 have a length in a first direction, a height in a second direction and a width in a third direction, wherein the three directions are each perpendicular to one another and accordingly define a Cartesian coordinate system. For each battery cell 7, its length is greater than its height, which in turn is greater than its width. The battery cells 7 are arranged adjacent to one another in the first direction, so that a height of the battery cell arrangement 3 corresponds to the height of one of the battery cells 7 and a width of the battery cell arrangement 3 corresponds to a width of one of the battery cells 7. The length of the battery cell arrangement 3, however, corresponds to a multiple of the length of the battery cells 7. In other words, the battery cells 7 are arranged in a row in the first direction to form the battery cell arrangement 3.

The battery cell arrangement 3 is mechanically connected to the temperature control element 4 of the temperature control device 5 via the holding projections 6. Preferably, a plurality of holding projections 6 extend from the temperature control element 4, as shown here, wherein each of the battery cells 7 is assigned, for example, such a holding projection 6. It can also be provided that for each of the battery cells 7, multiple holding projections 6 extend from the temperature control element 4. However, it can also be provided that the holding projection 6 runs continuously in the longitudinal direction of the temperature control element 4.

After assembly of the traction battery 1 or the cell module 2, the battery cells 7 are supported in a first direction on the temperature control element 4 and in a second direction different from the first direction on the holding projections 6 or the continuous holding projection 6. This first direction corresponds to the third direction already mentioned, so that the battery cells 7 of the battery cell arrangement 3 are supported in their transverse direction on the temperature control element 4 and in their vertical direction on the holding projection(s) 6. The temperature control element 4 and the holding projection 6 or the holding projections 7 are preferably designed together as an extruded profile. At least one fluid channel 10 (not visible here) is formed in the temperature control element 4, which channel is fluidically connected to a first fluid distributor 11 and to a second fluid distributor 12. The fluid channel 10 is fluidically connected to a fluid circuit via the fluid distributors 11 and 12.

FIG. 2 shows a schematic sectional view through a region of the traction battery 1, namely through the cell module 2. Firstly, it can be seen that the temperature control element 4 has a plurality of fluid channels 10, which preferably each have the same flow cross-section. The fluid channels 10 are preferably produced by extrusion of the temperature control element 4. On the other hand, it can be seen that a heat transfer medium 13 is present between the temperature control element 4 and the battery cell arrangement 3. The battery cell arrangement 3 and the temperature control element 4 are thermally coupled to one another via the heat transfer medium 13. This always ensures reliable and effective temperature control of the battery cell arrangement 3 by means of the temperature control element 4 or the temperature control device 5.

It can also be seen that the battery cell arrangement 3 or the battery cells 7 are supported on the holding projection 6. A component or profile forming the temperature control element 4 and the holding projection 6 is thus L-shaped. In this respect, it has two legs which are angled relative to each other, in particular perpendicular to each other. One of the legs is formed by the temperature control element 4 and another of the legs by the holding projection 6. The battery cell arrangement 3 is arranged in a space delimited by the legs, so that it is ultimately supported on both legs. This ensures excellent thermal connection and, at the same time, reliable mechanical guidance of the battery cell arrangement 3 with respect to the temperature control element 4.

### LIST OF REFERENCE NUMERALS

1 traction battery
2 cell module
3 battery cell arrangement
4 temperature control element
5 temperature control device
6 holding projection
7 battery cell
8 cell housing
9 electrode
10 fluid channel
11 1. fluid distributor
12 2. fluid distributor
13 heat transfer medium

1. A traction battery for a motor vehicle, with a cell module having a battery cell arrangement and a temperature control device for temperature control of the battery cell arrangement, wherein the temperature control device has a temperature control element having at least one fluid channel, against which the battery cell arrangement rests in a first direction and from which a holding projection extends, against which the battery cell arrangement is supported in a second direction different from the first direction.

2. The traction battery according to claim 1, wherein the battery cell arrangement rests against the temperature control element via a heat transfer medium, so that the temperature control element is thermally coupled to the battery cell arrangement via the heat transfer medium.

3. The traction battery according to claim 1, wherein the heat transfer medium is a foam, a thermal pad or a thermal paste.

4. The traction battery according to claim 1, wherein the holding projection overlaps the battery cell arrangement in the first direction over at least 50%, at least 75% or at least 100%.

5. The traction battery according to claim 1, wherein the holding projection is flush with the battery cell arrangement on a side of the battery cell arrangement facing away from the temperature control element.

6. The traction battery according to claim 1, wherein the temperature control element and the holding projection are manufactured in one piece and from the same material.

7. The traction battery according to claim 1, wherein the holding projection has dimensions in a third direction different from the first direction and the second direction, which correspond to at most 40%, at most 20% or at most 10% of dimensions of the temperature control element and/or of the battery cell arrangement in the same direction.

8. The traction battery according to claim 1, wherein the cell module is a first cell module, the battery cell arrangement is a first battery cell arrangement, the temperature control element is a first temperature control element and the holding projection is a first holding projection and in addition to the first cell module there is a second cell module with a second battery cell arrangement and a second temperature control element, wherein the second battery cell arrangement rests against the first temperature control element in the first direction and a second holding projection extends from the second temperature control element, on which holding projection the second battery cell arrangement is supported in the second direction.

9. The traction battery according to claim 1, wherein a further first holding projection extends from the first temperature control element, which projection is offset in a third direction different from the first direction and the second direction with respect to the second holding projection and is arranged overlapping therewith in the first direction and in the second direction.

10. A method for producing a traction battery for a motor vehicle, wherein the traction battery has a cell module having a battery cell arrangement and a temperature control device for temperature control of the battery cell arrangement, wherein the temperature control device has a temperature control element having at least one fluid channel, against which element the battery cell arrangement rests in a first direction and from which a holding projection extends, on which the battery cell arrangement is arranged supported thereon, in a second direction, which is different from the first direction.

11. The traction battery according to claim 2, wherein the heat transfer medium is a foam, a thermal pad or a thermal paste.

12. The traction battery according to claim 2, wherein the holding projection overlaps the battery cell arrangement in the first direction over at least 50%, at least 75% or at least 100%.

13. The traction battery according to claim 3, wherein the holding projection overlaps the battery cell arrangement in the first direction over at least 50%, at least 75% or at least 100%.

14. The traction battery according to claim 2, wherein the holding projection is flush with the battery cell arrangement on a side of the battery cell arrangement facing away from the temperature control element.

15. The traction battery according to claim 3, wherein the holding projection is flush with the battery cell arrangement on a side of the battery cell arrangement facing away from the temperature control element.

16. The traction battery according to claim 4, wherein the holding projection is flush with the battery cell arrangement on a side of the battery cell arrangement facing away from the temperature control element.

17. The traction battery according to claim 2, wherein the temperature control element and the holding projection are manufactured in one piece and from the same material.

18. The traction battery according to claim 3, wherein the temperature control element and the holding projection are manufactured in one piece and from the same material.

19. The traction battery according to claim 4, wherein the temperature control element and the holding projection are manufactured in one piece and from the same material.

20. The traction battery according to claim 5, wherein the temperature control element and the holding projection are manufactured in one piece and from the same material.
